(19) United States
(12) Patent Application Publication
(10) Pub. No.: US 2004/0029475 A1
(43) Pub. Date: Feb. 12, 2004

(54) Thermoplastic spatial fabric application

(76) Inventor: James Hung, Yun-Lin (TW)

Correspondence Address: CHARLES E. BAXLEY, ESQUIRE, Hart, Baxley, Daniels & Holton, 59 John St., 5 Fl., New York, NY, 10038, US

(21) Appl. No.: 10/216,308

(22) Filed: Aug. 12, 2002

(51) Int. Cl. B32B 5/26; B32B 5/02; B32B 27/04; B32B 27/12

(52) U.S. Cl. 442/199; 442/209; 442/243; 442/246

(57) ABSTRACT

A thermoplastic spatial fabric application includes at least two chemical fibers having different melting points. The chemical fibers are processed by a weaving technology, so that the chemical fibers may be intersected and formed, thereby forming a spatial fabric having multiple layers. In addition, the spatial fabric may be treated by a heating process, so that the chemical fiber having a lower melting point may be melted to form a layer having a greater strength and stiffness, and the chemical fiber having a higher melting point may maintain the original features to form a layer having an excellent softness, permeability and elasticity, thereby forming a spatial fabric product with predetermined physical features. Accordingly, the physical features (such as the stiffness, elasticity, softness or the like) of the spatial fabric may be designed previously so as to satisfy the practical requirements.

### BACKGROUND OF THE INVENTION

1. Field of the Invention

The present invention relates to a thermoplastic spatial fabric application, and more particularly to a thermoplastic spatial fabric application comprising at least two chemical fibers having different melting points. The chemical fibers are processed by a weaving technology, so that the chemical fibers may be intersected and formed, thereby forming a spatial fabric having multiple layers. In addition, the spatial fabric may be treated by a heating process, so that the chemical fiber having a lower melting point may be melted, thereby forming a spatial fabric product with predetermined physical features, so as to satisfy the practical requirements.

2. Description of the Related Art

A conventional cloth structure is usually made of cotton material, wool material, natural fiber or the like which is processed by a weaving technology to form the cloth structure. The conventional cloth structure made of the above-mentioned material has soft and deformable features. In the recent years, the cloth structure has various developments, and is available for different requirements of the industry. Especially, the chemical fiber cloth, such as the nylon cloth, non-woven cloth and the like, is dyed and processed easily, has a lower cost, is washed easily, and is used during a long-term, so that it is widely adopted and used in the industry. For example, the chemical fiber cloth is largely available for the clothes, shoes, hat, blanket, chair, partition plate and the like.

The chemical fiber cloth has to satisfy the requirements of thickness, elasticity, structural feature and the like. For example, the chemical fiber cloth needs to have an enough thickness, an enough stiffness, a proper elasticity and the like. The conventional method for making the chemical fiber cloth includes adopting multiple layers of cloth which are overlapped with each other, and providing glue and solvent (such as methyl benzene) which are coated between the multiple layers of cloth, so that the multiple layers of cloth may be bonded, thereby forming the cloth structure with the above-mentioned practical features.

It is appreciated that, the above-said conventional method for making the chemical fiber cloth has the following disadvantages.

1. In the cloth product made by bonding the multiple layers of cloth, the glue easily blocks each layer of cloth, thereby greatly reducing the permeability of the cloth structure.

2. When the multiple layers of cloth are bonded by the glue and the solvent, the solvent usually contains toxic material, thereby easily causing danger to the worker. In addition, after the cloth product is produced, the toxic material will be released gradually, thereby causing an environmental pollution.

3. In the cloth product made by bonding the multiple layers of cloth, the glue is easily broken by the ambient environment, such as the high temperature, the moisture and the like, during a period of time, so that the combination of the multiple layers of cloth becomes worse, thereby decreasing the structural strength of the cloth structure.

### SUMMARY OF THE INVENTION

The present invention has arisen to provide a spatial fabric which needs not to adopt the glue and solvent as is used in the conventional method for making the chemical fiber cloth, so as to overcome the disadvantages of the conventional method for making the chemical fiber cloth. The spatial fabric of the present invention may be formed to have predetermined physical features, such as the stiffness, elasticity, softness, permeability or the like, so as to satisfy the practical requirements.

The primary objective of the present invention is to provide a thermoplastic spatial fabric application comprising at least two chemical fibers having different melting points. The chemical fibers are processed by a weaving technology, so that the chemical fibers may be intersected and formed, thereby forming a spatial fabric having multiple layers. In addition, the spatial fabric may be treated by a heating process, so that the chemical fiber having a lower melting point may be melted to form a layer having a greater strength and stiffness, and the chemical fiber having a higher melting point may maintain the original features to form a layer having an excellent softness, permeability and elasticity, thereby forming a spatial fabric product with predetermined physical features. Accordingly, the physical features (such as the stiffness, elasticity, softness or the like) of the spatial fabric may be designed previously so as to satisfy the practical requirements.

In accordance with the present invention, there is provided a thermoplastic spatial fabric application, the spatial fabric comprising at least two chemical fibers having different melting points, the at least two chemical fibers being processed by a weaving technology, thereby forming the spatial fabric having multiple layers;

wherein, the spatial fabric may be treated by a heating process with a heating temperature higher than that of a chemical fiber having a lower melting point, and lower than that of a chemical fiber having a higher melting point, so that the chemical fiber having a lower melting point is melted, and the chemical fiber having a higher melting point is not melted, thereby changing original physical features of the spatial fabric.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a thermoplastic spatial fabric in accordance with a preferred embodiment of the present invention;

FIG. 2 is a side plan schematic view of the thermoplastic spatial fabric as shown in FIG. 1;

FIG. 3 is a schematic view of the thermoplastic spatial fabric, wherein the first layer and the third layer are melted; and

FIG. 4 is a schematic view of the thermoplastic spatial fabric, wherein the second layer is melted.

### DETAILED DESCRIPTION OF THE INVENTION

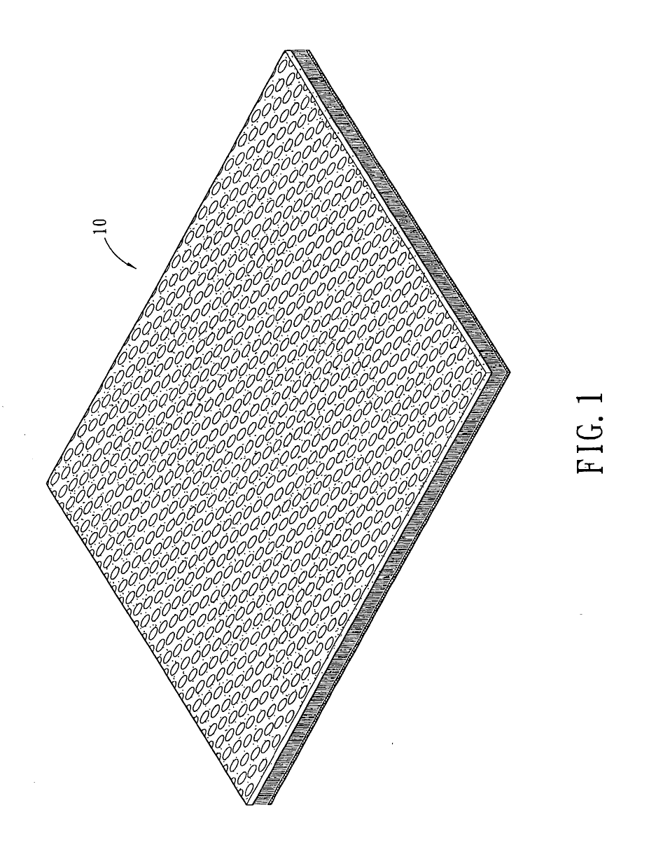

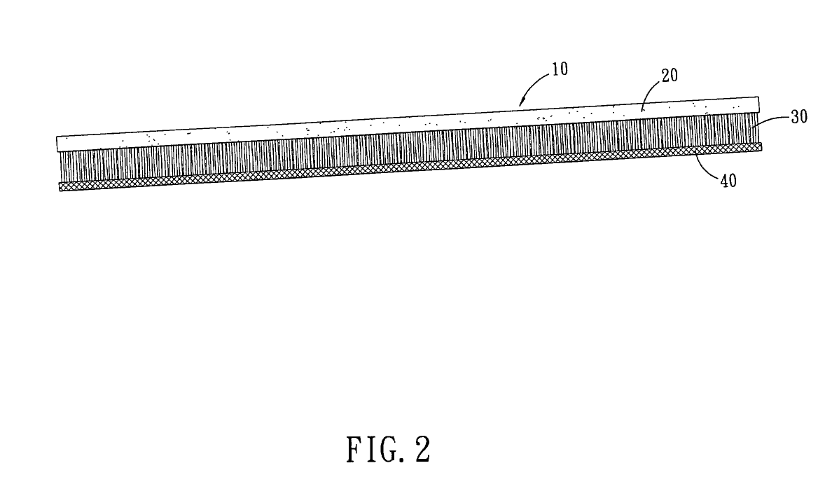

Referring to the drawings and initially to FIGS. 1 and 2, a thermoplastic spatial fabric application in accordance with a preferred embodiment of the present invention comprises at least two chemical fibers having different melting points which are processed by a weaving technology, thereby forming a spatial fabric 10. The predetermined chemical fiber may be melted by a heating process, thereby forming a spatial fabric product with predetermined physical features.

The spatial fabric may be processed by a weaving technology, so that different fibers, such as PP, PET, NYLON or the like, may interweave with each other, thereby forming the structure of the spatial fabric 10 having multiple layers. In addition, the layers of the spatial fabric 10 are integrally combined with each other by a weaving technology (such as interweaving, hooking or the like) as shown in FIG. 1.

The above-mentioned chemical fiber may be formed according to the practical requirement, or may be woven into a predetermined structural state, for example, a soft fabric state, an upright fiber state, a soft and elastic non-woven fabric state, and the like. It is appreciated that, the chemical fibers or the formed fabric have different melting points, wherein the melting point is the melting temperature when the fiber is melted.

The melting points of the popular chemical fibers are listed as follows.

The melting point of PET is about 260° C.

The melting point of Ny66 is about 260° C.

The melting point of Ny6 is about 220° C.

The melting point of PP is about 170° C.

The thermoplastic spatial fabric application in accordance with the present invention comprises at least two chemical fibers (such as PP, PET, Nylon or the like) having different melting points which are processed by a weaving technology, so that the at least two different chemical fibers may interweave with each other, thereby forming the structure of the spatial fabric 10 having multiple layers.

Accordingly, the spatial fabric 10 may be treated by a heating process, wherein the heating temperature is higher than that of the chemical fiber having a lower melting point, and is lower than that of the chemical fiber having a higher melting point, so that the chemical fiber having a lower melting point is melted, and the chemical fiber having a higher melting point is not melted, thereby changing the original physical features of the spatial fabric 10, such as the stiffness, elasticity, softness, permeability or the like.

In the following descriptions, two preferred embodiments are illustrated, wherein the spatial fabric 10 consists of three layers.

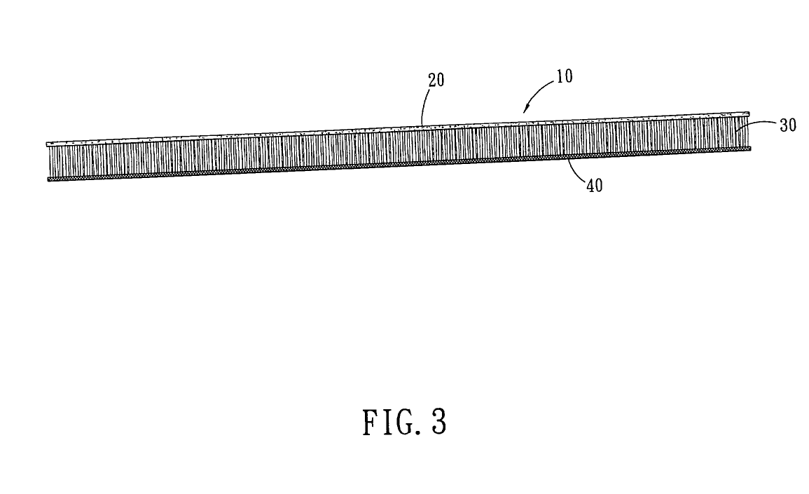

Referring to FIGS. 1 and 3, the spatial fabric 10 in accordance with a first embodiment of the present invention consists of three layers, wherein the outside of the spatial fabric 10 has an excellent strength and stiffness, and the inside of the spatial fabric 10 has an excellent elasticity and permeability. The spatial fabric 10 includes a first layer 20, a second layer 30 and a third layer 40. The first layer 20 is made of a yarn containing the PP fiber with a melting point equal to 170° C. The first layer 20 may be formed into a cloth layer structural state. The second layer 30 is intersected with and juxtaposed to the first layer 20, and is made of a PET fiber with a melting point equal to 260° C. The second layer 30 may have an upright fiber state. The third layer 40 is intersected with and juxtaposed to the second layer 30, and is made of a yarn containing the PP fiber with a melting point equal to 170° C. The third layer 40 may be formed into a cloth layer structural state.

In such a manner, the spatial fabric 10 may be heated to increase the temperature, and may be pressurized so that the PP fibers of the first layer 20 and the third layer 40 may be pressed properly. When the heating temperature is greater than or equal to 170° C. and is smaller than 260° C., the PP fibers of the first layer 20 and the third layer 40 are melted gradually, and are combined with the PET fibers of the second layer 30. At this time, the heating temperature does not reach the melting point of the PET fibers of the second layer 30, so that the PET fibers of the second layer 30 are not melted and will keep the original state.

Then, the heating temperature is decreased gradually, so that the PP fibers of the first layer 20 and the third layer 40 are solidified and formed. After the PP fibers of the first layer 20 and the third layer 40 are solidified, the fibers of the first layer 20, the second layer 30 and the third layer 40 of the spatial fabric 10 are integrally and closely combined with each other. Thus, the structure of the first layer 20 and the third layer 40 has a greater strength and stiffness, and the fiber of the second layer 30 has an excellent elasticity and permeability, so that the spatial fabric 10 as shown in FIG. 3 has a greater strength and stiffness, and has an excellent elasticity, softness and permeability.

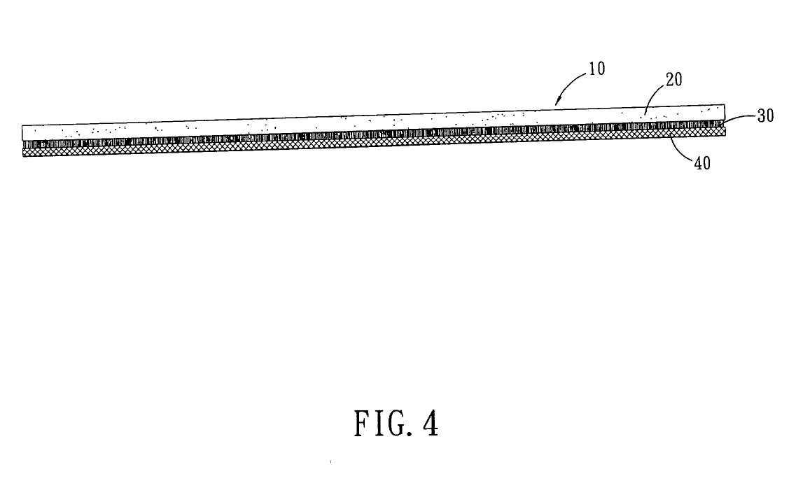

Referring to FIGS. 1 and 4, the spatial fabric 10 in accordance with a second embodiment of the present invention consists of three layers, wherein the inside of the spatial fabric 10 has an excellent strength and stiffness, and the outside of the spatial fabric 10 has an excellent elasticity, softness and permeability. The spatial fabric 10 includes a first layer 20, a second layer 30 and a third layer 40. The first layer 20 is made of a PET fiber with a melting point equal to 260° C. The first layer 20 may be formed into a soft cloth layer structural state. The second layer 30 is intersected with and juxtaposed to the first layer 20, and is made of a yarn containing the PP fiber with a melting point equal to 170° C. The second layer 30 may have an upright fiber state. The third layer 40 is intersected with and juxtaposed to the second layer 30, and is made of a PET fiber with a melting point equal to 260° C. The third layer 40 may be formed into a soft cloth layer structural state.

In such a manner, the spatial fabric 10 may be heated to increase the temperature, and may be pressurized so that the PP fibers of the second layer 30 may be pressed properly. When the heating temperature is greater than or equal to 170° C. and is smaller than 260° C., the PP fibers of the second layer 30 are melted gradually, and are combined with the PET fibers of the first layer 20 and the third layer 40. At this time, the heating temperature does not reach the melting point of the PET fibers of the first layer 20 and the third layer 40, so that the PET fibers of the first layer 20 and the third layer 40 are not melted and will keep the original state.

Then, the heating temperature is decreased gradually, so that the PP fibers of the second layer 30 are solidified and formed. After the PP fibers of the second layer 30 are solidified, the fibers of the first layer 20, the second layer 30 and the third layer 40 of the spatial fabric 10 are integrally and closely combined with each other. Thus, the structure of the second layer 30 has a greater strength and stiffness, and the fiber of the first layer 20 and the third layer 40 has an excellent softness and elasticity, so that the spatial fabric 10 as shown in FIG. 4 has a greater strength and stiffness, and has an excellent softness and elasticity.

Accordingly, the spatial fabric 10 in accordance with the present invention is made by using the difference of the melting points of the chemical fibers, and is treated by a heating process, so that the chemical fiber of at least one predetermined layer of the spatial fabric 10 may be melted to form a layer having a greater strength and stiffness, and the chemical fiber of at least one predetermined layer of the spatial fabric 10 may maintain the original features to form a layer having an excellent softness, permeability and elasticity. Thus, the spatial fabric 10 in accordance with the present invention may satisfy the practical requirements of the industry. For example, the spatial fabric 10 in accordance with the present invention is largely available for the clothes, shoes, hat, blanket, chair, partition plate and the like. Thus, the spatial fabric 10 in accordance with the present invention needs not to adopt the glue and solvent as is used in the conventional method for making the chemical fiber cloth, and may overcome the disadvantages of the conventional method for making the chemical fiber cloth.

In conclusion, the thermoplastic spatial fabric application in accordance with the present invention comprises at least two chemical fibers having different melting points which are processed by a weaving technology, so that the chemical fibers may be intersected and formed, thereby forming a spatial fabric 10 having multiple layers. In addition, the spatial fabric 10 in accordance with the present invention may be treated by a heating process, so that the chemical fiber having a lower melting point may be melted to form a layer having a greater strength and stiffness, and the chemical fiber having a higher melting point may maintain the original features to form a layer having an excellent softness, permeability and elasticity, thereby forming a spatial fabric product with predetermined physical features. Accordingly, the physical features (such as the stiffness, elasticity, softness or the like) of the spatial fabric 10 may be designed previously so as to satisfy the practical requirements.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A thermoplastic spatial fabric application, the spatial fabric comprising at least two chemical fibers having different melting points, the at least two chemical fibers being processed by a weaving technology, thereby forming the spatial fabric having multiple layers;
wherein, the spatial fabric may be treated by a heating process with a heating temperature higher than that of a chemical fiber having a lower melting point, and lower than that of a chemical fiber having a higher melting point, so that the chemical fiber having a lower melting point is melted, and the chemical fiber having a higher melting point is not melted, thereby changing original physical features of the spatial fabric.

2. The thermoplastic spatial fabric application in accordance with claim 1, wherein the spatial fabric is a structure having three layers.

3. The thermoplastic spatial fabric application in accordance with claim 2, wherein the spatial fabric includes a first layer, a second layer and a third layer, the first layer is made of a yarn containing the PP fiber with a melting point equal to 170° C., the second layer is intersected with and juxtaposed to the first layer, and is made of a PET fiber with a melting point equal to 260° C., the third layer is intersected with and juxtaposed to the second layer, and is made of a yarn containing the PP fiber with a melting point equal to 170° C.;
whereby, the spatial fabric may be heated to increase a heating temperature, so that when the heating temperature is greater than or equal to 170° C. and is smaller than 260° C., the PP fibers of the first layer and the third layer are melted gradually, and are combined with the PET fibers of the second layer, when the heating temperature is decreased gradually, the PP fibers of the first layer and the third layer are solidified and formed, and after the PP fibers of the first layer and the third layer are solidified, the fibers of the first layer, the second layer and the third layer of the spatial fabric are integrally and closely combined with each other, and the spatial fabric has a greater strength and stiffness by the structure of the first layer and the third layer, and has an excellent elasticity and permeability by the fiber of the second layer.

4. The thermoplastic spatial fabric application in accordance with claim 2, wherein the spatial fabric includes a first layer, a second layer and a third layer, the first layer is made of a PET fiber with a melting point equal to 260° C., the second layer is intersected with and juxtaposed to the first layer, and is made of a yarn containing the PP fiber with a melting point equal to 170° C., the third layer is intersected with and juxtaposed to the second layer, and is made of a PET fiber with a melting point equal to 260° C.;
whereby, the spatial fabric may be heated to increase a heating temperature, so that when the heating temperature is greater than or equal to 170° C. and is smaller than 260° C., the PP fibers of the second layer are melted gradually, and are combined with the PET fibers of the first layer and the third layer, when the heating temperature is decreased gradually, the PP fibers of the second layer are solidified and formed, and after the PP fibers of the second layer are solidified, the fibers of the first layer, the second layer and the third layer of the spatial fabric are integrally and closely combined with each other, and the spatial fabric has a greater strength and stiffness by the structure of the second layer, and has an excellent softness and elasticity by the fibers of the first layer and the third layer.
